(19) United States
(12) Patent Application Publication
(10) Pub. No.: US 2008/0123537 A1
(43) Pub. Date: May 29, 2008

(54) Method and Apparatus for Facilitating the Detection of Loop-Back Conditions in Computer Networks

(76) Inventors: David B. Kumhyr, Austin, TX (US); Gerald F. McBrearty, Austin, TX (US); Johnny M. Shieh, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/564,707

(22) Filed: Nov. 29, 2006

(51) Int. Cl. G06F 11/00

(52) U.S. Cl. 370/249

(57) ABSTRACT

A method and apparatus for facilitating the detection of a loop-back condition within a computer network is disclosed. All hubs within the computer network are continuously monitored for a loop-back condition. In response to an occurrence of a loop-back condition detected at a hub within the computer network, a discernable signal is emitted at the hub.

### BACKGROUND OF THE INVENTION

1. Technical Field

The present invention relates to computer networks in general, and more particularly, to loop-back conditions in computer networks. Still more particularly, the present invention relates to a method and apparatus for facilitating the detection of loop-back conditions in a computer network.

2. Description of Related Art

Local-area networks (LANs) are commonly utilized to provide inter-connectivities among computer systems within a relatively small local area, such as a home or an office. Within a LAN, data can be shared among computer systems via various well-known protocols.

Although redundant links and/or multiple routers can be employed within LANs to insure network integrity, LANs are still susceptible to uncomplicated user errors. For example, a loop-back condition can occur within a LAN when a user connects both ends of a single network cable into a switch, which leads to a closed-loop or short that can result in a cascading failure of the LAN. Loop-back conditions often occur in conference rooms of large organizations when an employee inadvertently connects the open end of a network cable already connected to a hub back into the same hub in an effort to stow the network cable in a neatly fashion.

While the detection and deactivation of loop-back conditions occurred within a LAN can be facilitated by specialized software installed within a hub and/or switch, a large amount of time is still required to search for the physical location of the loop-back condition, especially in a large organization. Consequently, it would be desirable to provide an improved method and apparatus for facilitating the detection of the physical location of a loop-back condition within a computer network.

### SUMMARY OF THE INVENTION

In accordance with a preferred embodiment of the present invention, all hubs within a computer network are continuously monitored for a loop-back condition. In response to an occurrence of a loop-back condition detected at a hub within the computer network, a discernable signal is emitted at the hub. The discernable signal can be, for example, an audible tone, and the hub keeps emitting the audible tone until the loop-back condition is corrected.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a local-area network (LAN) in which a preferred embodiment of the present invention can be implemented;

FIG. 2 is a block diagram of a hub within the LAN from FIG. 1, in accordance with a preferred embodiment of the present invention; and

FIG. 3 is a high-level logical flow diagram of a method for facilitating the detection of a loop-back condition within a computer network, in accordance with a preferred embodiment of the present invention.

### DETAILED DESCRIPTION OF A PREFERRED EMBODIMENT

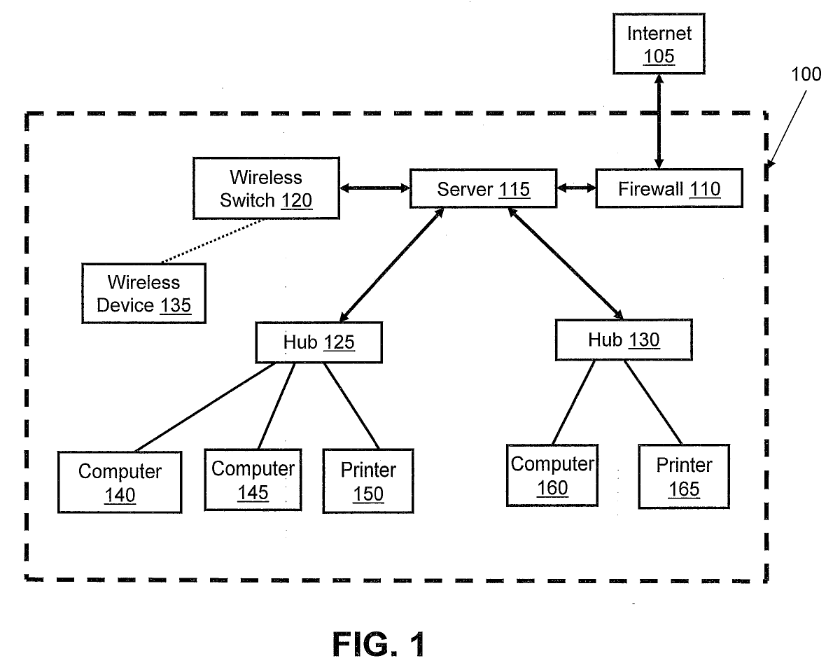

Referring now to the drawings, and specifically to FIG. 1, there is depicted a block diagram of a local-area network (LAN) in which a preferred embodiment of the present invention can be implemented. As shown, a LAN 100 includes a server 115, a wireless switch 120, a hub 125 and a hub 130. Although only two hubs are depicted in FIG. 1, it is understood by those skilled in the art that LAN 100 may include more than two hubs. LAN 100 is connected to Internet 105 via a firewall 110 that prevents unauthorized access to LAN 100 by users of Internet 105.

Wireless switch 120 enables a wireless device 135 to be wirelessly connected to LAN 100. Hub 125 enables a computer 140, a computer 145, a printer 150, as well as other devices connected to LAN 100, to communicate with each other. Similarly, hub 130 enables a computer 160, a printer 165, as well as with other devices connected to LAN 100, to communicate with each other.

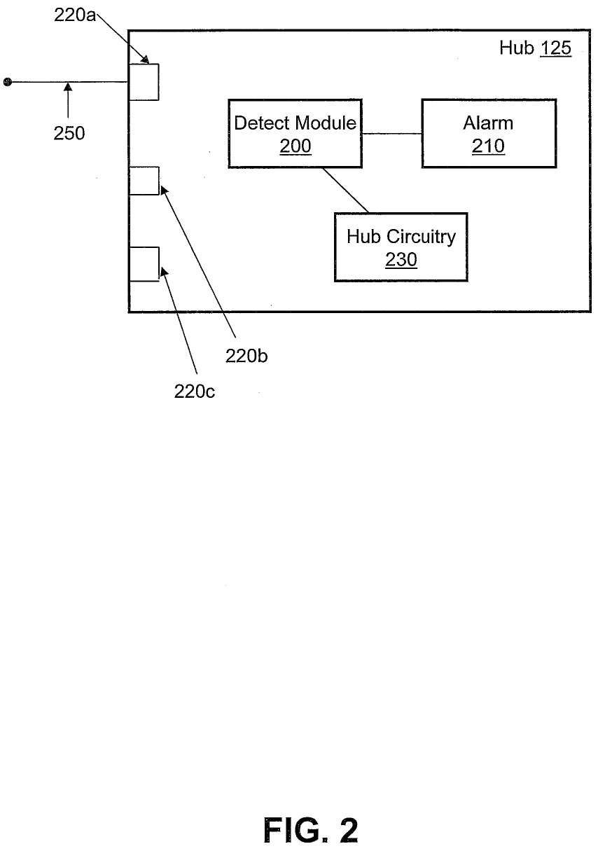

Since hub 125 and hub 130 are substantially identical to each other; thus, only hub 125 will be further described in details. With reference now to FIG. 2, there is illustrated a block diagram of hub 125, in accordance with a preferred embodiment of the present invention. As shown, hub 125 includes a detect module 200 and an alarm 210 along with other hub circuitry 230. Hub 125 also includes connectors 220a-220c, each being adapted to receive a network cable.

A network cable 250, for example, has one end connected to connector 220a while the other end is left unconnected. If the other end of network cable 250 is inadvertently connected back to hub 125 via one of connectors 220b-220c, a loop-back condition is formed. A loop-back condition is defined as a condition formed by having both ends of a network cable connected to a same hub, switch, router, or similar device within a LAN. A loop-back condition can also be formed by a network cable connected to a device that produces a short circuit or electrical current loop. Such condition occurs when, for example, a crossover cable is connected between computer 140 and hub 125 in FIG. 1.

Detect module 200 is configured to detect any occurrence of a loop-back condition within hub 125. When detect module 200 detects an occurrence of a loop-back condition, detect module 200 activates alarm 210 to emit an audible tone. The audible tone is preferably loud, direct, and continuous in order to maximize the likelihood of it to be heard by anyone who is attempting to locate the hub in which the loop-back condition exists.

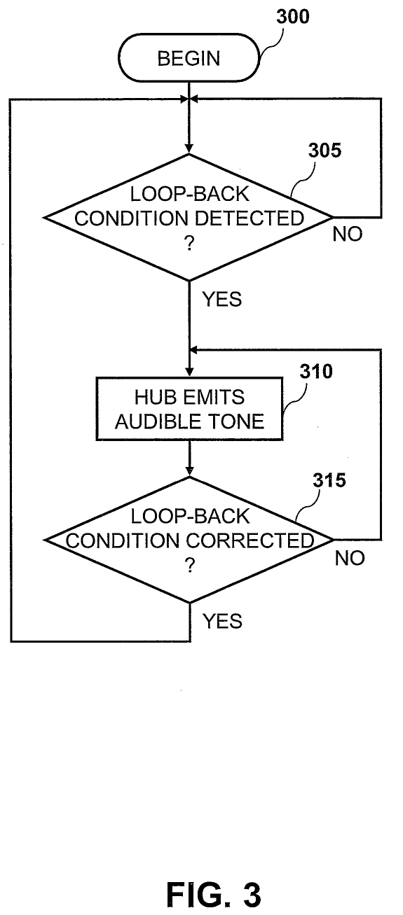

Referring now to FIG. 3, there is depicted a high-level logical flow diagram of a method for facilitating the detection of a loop-back condition within a LAN, such as LAN 100 from FIG. 1, in accordance with a preferred embodiment of the present invention. Starting at block 300, a hub (such as hub 125 from FIG. 1) within a LAN monitors all connection points for a loop-back condition. The monitoring can be preformed by utilizing a detect module (such as detect module 200 from FIG. 2) along with specific software that are designed for such purpose. A determination is made whether or not a loop-back condition is detected by the hub, as shown in block 305. If a loop-back condition is not detected by the hub, the process returns to block 305 to continue with the monitoring process.

However, if a loop-back condition is detected by the hub, the hub emits an audible tone, as depicted in block 310. The audible tone enables a person who is attempting to solve the loop-back condition within the LAN to locate the infringing hub quickly.

A determination is made whether or not the detected loop-back condition has been corrected, as shown in block 315. If the detected loop-back condition has not been corrected, the process returns to block 310. Otherwise, if the detected loop-back condition has been corrected, such as unplugging one or both ends of the network cable that causes the loop-back condition, the process returns to block 305 to continue with the monitoring process.

As has been described, the present invention provides a method and apparatus for facilitating the detection of the physical location of the loop-back condition within a LAN. The present invention enables multiple hubs within a LAN to detect loop-back conditions and notify users when loop-back conditions are detected. As such, a user can efficiently locate the sources of any loop-back condition and quickly correct the loop-back condition in order to minimizing network maintenance/service time.

While the invention has been particularly shown and described with reference to a preferred embodiment, it will be understood by those skilled in the art that various changes in form and detail may be made therein without departing from the spirit and scope of the invention.

What is claimed is:

1. A method for facilitating the detection of a loop-back condition within a computer network, said method comprising:
monitoring a hub within a computer network for a loop-back condition;
determining whether or not a loop-back condition occurred at a hub within said computer network; and
in response to a determination that a loop-back condition occurred at a hub within said computer network, emitting a discernable signal at said hub.

2. The method of claim 1, wherein said loop-back condition occurs when both ends of a network cable are connected to said hub.

3. The method of claim 1, wherein said emitting further includes emitting said discernable signal at said hub continuously until said loop-back condition is corrected.

4. The method of claim 1, wherein said discernable signal is a continuous audible tone.

5. The method of claim 1, wherein said discernable signal is a flashing light.

6. The method of claim 1, wherein said discernable signal is a vibrating signal.

7. An apparatus for facilitating the detection of a loop-back condition within a computer network, said apparatus comprising:
a detect module for monitoring a hub within a computer network for a loop-back condition;
means for determining whether or not a loop-back condition occurred at a hub within said computer network; and
an alarm, in response to a determination that a loop-back condition occurred at a hub within said computer network, for emitting a discernable signal at said hub.

8. The apparatus of claim 7, wherein said loop-back condition occurs when both ends of a network cable are connected to said hub.

9. The apparatus of claim 7, wherein said alarm further includes means for emitting said discernable signal at said hub continuously until said loop-back condition is corrected.

10. The apparatus of claim 7, wherein said discernable signal is a continuous audible tone.

11. The apparatus of claim 7, wherein said discernable signal is a flashing light.

12. The apparatus of claim 7, wherein said discernable signal is a vibrating signal.
